(19) United States
(12) Patent Application Publication
(10) Pub. No.: US 2014/0341753 A1
(43) Pub. Date: Nov. 20, 2014

(54) HEATING ELEMENTS

(71) Applicant: BROWN CRAVENS TAYLOR, Sebastopol, CA (US)

(72) Inventor: Curtis Del Brown, Nevada City, CA (US)

(73) Assignee: BROWN CRAVENS TAYLOR, Sebastopol, CA (US)

(21) Appl. No.: 14/279,657

(22) Filed: May 16, 2014

Related U.S. Application Data
(60) Provisional application No. 61/823,972, filed on May 16, 2013.

(51) Int. Cl. H02K 44/00; F04B 37/02

(52) U.S. Cl. CPC H02K 44/00; F04B 37/02
USPC 417/50

(57) ABSTRACT

A heating element and a system of heating elements are disclosed. The heating element includes a body that is permeable to a fuel species and that includes a dopant with an affinity for the fuel species. Reactions of the fuel species at the dopant generate heat. Magnetic and electric fields are utilized to move the fuel species through the heating element.

This application claims priority to U.S. Provisional Application No. 61/823,972 filed on May 16, 2013. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is heating elements.

### BACKGROUND

The production of heat has been historically accomplished directly or indirectly by the burning or oxidation of chemical fuel, by friction, by alternative energy sources such as conversion of solar or wind power, or by nuclear energy, specifically fission. While each has certain advantages, these techniques either consume rare or increasingly scarce fuel or use renewable but unreliable sources. Nuclear energy via fission has the disadvantage of nuclear waste. What is needed is a source of heat using fuel continuously available in essentially unlimited quantities

Attempts have been made to utilize materials that have an affinity for hydrogen to facilitate production of heat using hydrogen as an energy source. For example, European Patent No. EP 0767962B1 (to Piantelli) describes a device that utilizes an electrode that receives and sequesters a hydrogen isotope within the crystalline lattice structure of the electrode material under the influence of a magnetic field. Subsequent heating of the material results in the initiation of a fusion reaction. Unfortunately, the available reaction area of such an electrode is limited, and there is no provision for replacement of spent hydrogen fuel.

In a related approach, United States Patent Application No. 2008/0123793 describes the use of carbon nanotubes that have been processed to have open ends to capture and retain hydrogen fuel for use in fusion reactions. Such materials are difficult to manufacture reproducibly and in quantity, however, and it is not clear how durable a carbon nanotube will be at high temperatures.

Previously, the Applicants have pioneered new and novel heating elements as disclosed in co-owned U.S. patent application publication 2011/0300002 (to Cravens et al). These utilize a hydrogen permeable ceramic matrix that includes metallic particles that have an affinity for hydrogen and/or hydrogen isotopes, and imbedded driver and control elements.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for a simple and effective heating element that utilizes hydrogen and/or a hydrogen isotope as an energy source.

### SUMMARY OF THE INVENTION

The inventive subject matter provides apparatus, systems and methods in which an improved heating element that includes electric field generators, magnetic field generators, or electric/magnetic field generators configured to produce controllable drive fields, and which consumes a hydrogen or hydrogen isotope fuel to generate heat.

One embodiment of the inventive concept is an apparatus that includes a main body that is permeable to a fuel, where the main body includes a dopant that has an affinity for the fuel species and at least one magnetic field source (for example, a coil) that generates a magnetic field which intersects the main body. The fuel species is responsive to the magnetic field, which provides an impulse that moves the fuel species through the main body.

Another embodiment of the inventive concept is an apparatus that includes a main body that is permeable to a fuel, where the main body includes a dopant that has an affinity for the fuel species and at least one electric field source (for example, an electrode) that generates an electric field which intersects the main body. The fuel species is responsive to the electric field, which provides an impulse that moves the fuel species through the main body.

Another embodiment of the inventive concept is an apparatus that includes a main body that is permeable to a fuel, where the main body includes a dopant that has an affinity for the fuel species and at least one electric field source (for example, an electrode) that generates an electric field which intersects the main body and at least one magnetic field source (for example, a coil) that generates a magnetic field which intersects the main body. In such an embodiment the electric field and the magnetic field can be independent of one another. In some embodiments the coil of a magnetic field source can act as an electrode for an electric field source (for example, by being in electrical communication with a voltage source). The combined magnetic field and electric field can comprise a drive field. Such a drive field can impart a motion to the fuel species to move it through the main body, for example using rotary motion, a periodic motion, an oscillatory motion, and/or a superwave motion.

Another embodiment of the inventive concept is a system that includes two or more heating elements that are permeable to a fuel. In such a system each heating element has a main body that includes a dopant that has an affinity for the fuel, at least one set of two magnetic coils that are in contact with an external surface of the main body, and a voltage source that is in contact with each of a set of two magnetic coils so as to generate an electric field between them. Such a system can also include a control system that can modulate the activity of at least one of the magnetic coils and at least one voltage source of at least one of the heating elements of the system. In some embodiments of the inventive concept the control system can control two or more of the heating elements of the system. The heating elements of such a system can be arranged in a linear arrangement, a two dimensional array, or a three dimensional array.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIGS. 1A to 1C schematically depict different embodiments for the application of electric (FIG. 1A), magnetic (FIG. 1B), and both electric and magnetic fields (FIG. 1C) to the body of a heating element of the inventive concept.

FIG. 2 is a schematic representation of a electric/magnetic field generator of the inventive concept.

FIG. 3 is a representation of a heating element of the inventive concept in which a schematic representation of an assembly of electric/magnetic field generators is overlayed on a representation of an external view of a heating element.

### DETAILED DESCRIPTION

The following description includes information that may be useful in understanding the present invention. It is not an admission that any of the information provided herein is prior art or relevant to the presently claimed invention, or that any publication specifically or implicitly referenced is prior art.

The inventive subject matter provides apparatus, systems and methods in which a heating element includes a main body and a plurality of field generators. The main body comprising a material that is permeable to a fuel species (for example, hydrogen and/or hydrogen isotopes), for example a ceramic material, that includes a dopant that has an affinity for the fuel species. Such an apparatus can include a plurality of field generators disposed at intervals along the exterior of the main body, for example wrapping around the main body. In some embodiments the main body can be formed as a torus and the generators can include individual conducting coils disposed evenly around the circumference of the torus. A potential can be applied to such coils to generate a potential difference between neighboring coils. In such an embodiment the coils can generate an electric field, a magnetic field, and/or both electric and magnetic fields that intersect and interact with the main body and/or materials within the main body. Such fields can act on a fuel species to provide an impulse (i.e. a force, stimulation, excitation, etc. that induces motion or applies energy) to the fuel species. For example such an impulse can induce translational motion in a fuel species so as to produce a bulk flow of the fuel species along a vector, increase a local density of a fuel species within a volume, impress a fuel species against an impermeable or partially permeable substance, or a combination of these. As used herein, the term impulse does not connote a specific waveform, periodicity (or lack thereof), and/or pattern unless otherwise specified.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

One should appreciate that heating elements of the inventive concept generate heat using widely available fuels while generating no harmful waste, and that the embodiments described herein provide simple and scalable means for manufacturing such heating elements.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Embodiments of the inventive concept can include a solid state matrix that forms at least part of a main body of a heating element. In a preferred embodiment, the material composing the main body is permeable (for example, by virtue of being porous) with respect to a fuel species. In preferred embodiments the solid state matrix can be a ceramic or can incorporate a zeolite. The solid state matrix can incorporate one or more dopants that have an affinity for fuel species utilized in the heating element. Such dopants can be in the form of discrete metallic particles, crystalline species, inclusions, etc. For example, if the fuel species is hydrogen or a hydrogen isotope, suitable dopants can include palladium or nickel.

The main body of the heating elements can be in contact with a plurality of driving elements (for example magnetic field coils and electrodes) that provide one or more driving fields (for example, a magnetic field, an electric field, and/or a combination of an electric field and a magnetic field) to which the fuel species is responsive. For example, a number of such driving elements can be wrapped around an exterior surface of the main body. Examples of suitable driving fields include magnetic fields, electrical fields, and magnetic and electrical fields used in combination (i.e. an electric/magnetic field).

Accordingly, preferred fuel species are susceptible to a driving field, for example an electric, magnetic, and/or electric/magnetic driving field. For example, a fuel compound could be ionized or polarized. Such driving fields can impart motion to fuel species, which in turn can be used to move such fuel species. In some embodiments of the inventive concept the driving field is configured to move molecules and/or ions of the fuel species through the main body of the heating element. The main body preferably includes one or more control points configured to generate a driving field capable of moving the fuel compound within the main body of the element.

Without being limited to theory, it is contemplated that interactions between the fuel species and the dopants within the main body result in the generation of energy, for example in the form of heat. The heat generated can be increased by causing the fuel to move within the main body under the influence of the driving fields. It is also believed that fuel consumed through such interactions would generate one or more waste species that could be removed. Such waste species could be of value as well.

The inventive aspects of the subject matter include apparatus and methods for modulation of the energy, physical features providing for an increase in the rate of energy release, optimization of materials for quantity and efficiency of heat release, and provision for fueling and maintenance. Preferably the energy released is in the form of heat. The inventive subject matter is also considered to include controlling or otherwise managing production of waste material.

In a preferred embodiment of the inventive concept the fuel species utilized is deuterium or a deuterium ion. It is contemplated, however, that hydrogen, tritium, and mixtures of different hydrogen isotopes and/or their ions can be suitable fuel species. In such a deuterium fueled heating element, it is contemplated that electric and/or magnetic flux improves operation or performance of the heating element. Among other techniques, the flux can be generated via electric fields across or within a main body of the heating element, magnetic fields across or within the main body of the heating element, or by the combined action of electric and magnetic fields. Such magnetic and and/or electric fields can be generated using one or more electric field generators, magnetic field generators, and/or one or more electric/magnetic field generators. For example, a plurality of such electric, magnetic, and/or electric/magnetic field generators can be disposed about the main body of a heating element of the inventive concept in order to both induce and direct flow of fuel species through the main body.

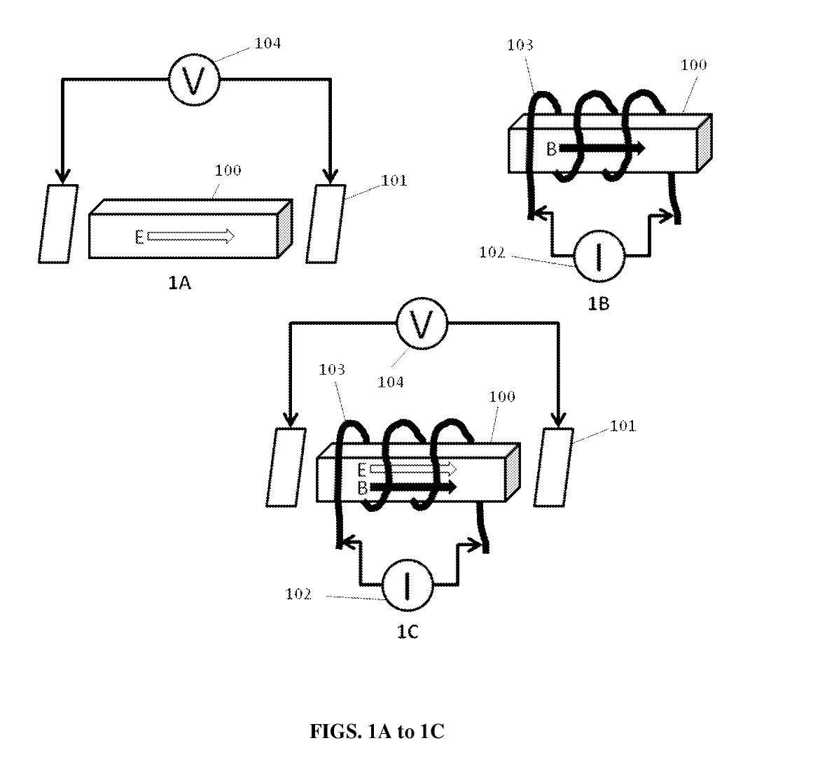

As shown in FIG. 1A, a heating element of the inventive concept can include an electric field generator, where one or more electrode(s) 101 are associated with a main body 100 and in electrical communication with a voltage source 104. Such an electrode 101 (or electrodes) is positioned or configured to produce an electric field within the main body 100. An electrode 101 can be fully or partially imbedded in the main body 100, or can be placed at or near an external surface of the main body 100. For example, an electrode 101 can be configured as a band, loop, and/or coil of conductive material that fully or partially encircles a portion of the main body 100.

As shown in FIG. 1B, a heating element of the inventive concept can include one or more magnetic field generator(s), where one or more coil(s) 103 are associated with a main body 100 and is in electrical communication with a current source 102. Such a coil 103 (or coils) is positioned or configured to produce a magnetic field within the main body 100. A coil 103 can be fully or partially imbedded in the main body 100, or can be placed at or near an external surface of the main body 100. For example, a coil 103 can be configured as a strand of conductive material that is wrapped around a portion of the main body 100.

As shown in FIG. 1C, a heating element of the inventive concept can include both an electric field generator and a magnetic field generator, where one or more electrode(s) 101 and one or more coil(s) 103 are associated with a main body 100. In such an embodiment, an electrode 101 (or electrodes) is in electrical communication with a voltage source 104 and is positioned or configured to produce an electric field within the main body 100. Similarly, one or more coil(s) 103 are associated with a main body 100 and is in electrical communication with a current source 102 and is positioned or configured to produce a magnetic field within the main body 100. In combination, such an electric field and magnetic field can be considered an electric/magnetic field. An electrode 101 and/or a coil 103 can be fully or partially imbedded in the main body 100, or can be placed at or near an external surface of the main body 100. For example, an electrode 101 can be configured as a band of conductive material that fully or partially encircles a portion of the main body 100, and a coil 103 can be configured as a strand of conductive material that is wrapped around a portion of the main body 100. It should be appreciated that such an arrangement permits independent control and/or manipulation of the electric field and of the magnetic field applied to the main body 100.

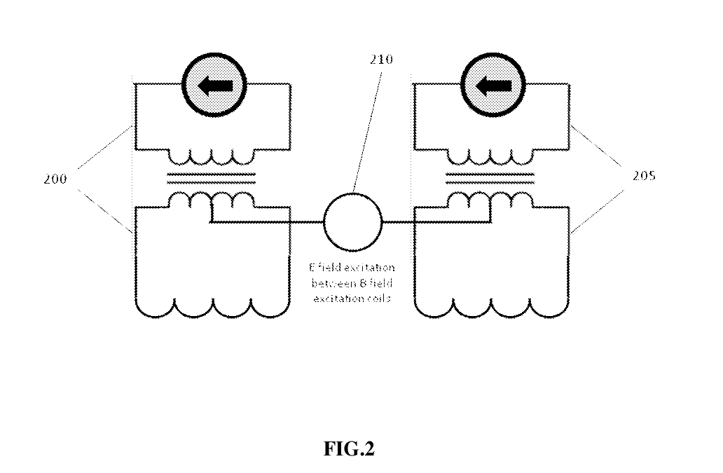

In a preferred embodiment of the inventive concept, a pair of magnetic coils used to generate magnetic fields can be utilized as electrodes that generate an independent electric field, thereby acting as an electric/magnetic field generator. A schematic depiction of such an embodiment is found in FIG. 2, which depicts such an electric/magnetic field generator, which can be used singly or as part of a plurality of such generators that can be disposed about the heating element's main body. The generators of FIG. 2 support generating both an electric field flux and a magnetic field flux. As shown, magnetic field coils 200, 205 provide a magnetic field (B field) that penetrates at least partially into the main body of the heating element. The orientation of the B field is indicated by arrows associated with the magnetic field coils 200, 205. A voltage source 210 is shown in electrical contact between components of the magnetic field coils 200 and magnetic field coils 205, and can be configured to produce a potential difference between them thereby generating an electrical field (E field) between the magnetic field coils 200 and 205 that penetrates at least partially into the main body of the heating element. It is contemplated that each of the magnetic field coils 200, 205 and the voltage source 210 can be independently controlled so as to provide fine and/or localized control of both the magnetic and electrical field flux thus generated within the heating element's main body.

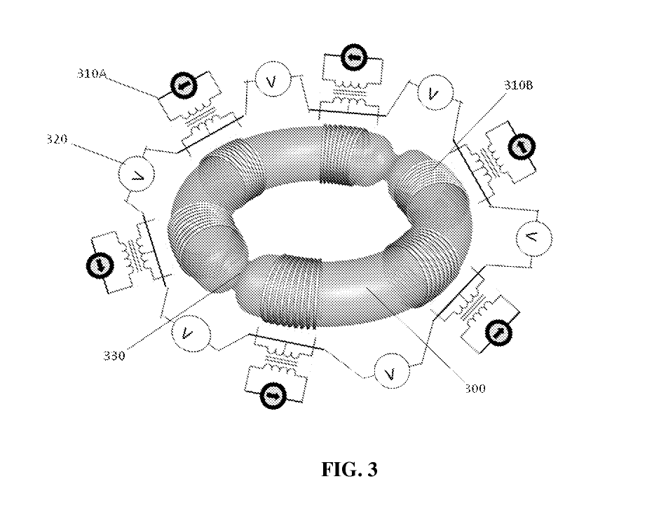

FIG. 3 depicts a heating element of the inventive concept, and provides an overlay of a schematic of the electric/magnetic field generators arranged about a heating element. The main body 300 of the heating element is configured as a torus. Multiple magnetic generator coils (depicted schematically as 310A and in a typical physical embodiment as 310B are disposed about and wrapped around the exterior surface of the toroidal body of the heating element. In the example shown, each magnetic generator coil 310A, 310B comprises a conducting wire coil wrapped around the main body, which greatly simplifies construction of the heating element. Such a configuration allows for generation of magnetic fields in the coil and within the main body. Application of an electric potential between such coils by a voltage source provides electric fields within the gaps between the coils, and permits a pair of such magnetic coils that are in electrical contact with a voltage source to act as an electric/magnetic field generator. By employing isolation coupling as shown, magnetic flux regions may be separated from other flux regions and hence moved to different voltage potentials, which give rise to electric fields between the magnetic flux regions.

In some embodiments of the inventive concept the main body can include one or more constrictions 330. Such constrictions 330 can serve to increase the local density or concentration of fuel species as they move through the main body. It is contemplated that the rate of reaction of the fuel species can be increased within such constrictions 330. Although depicted in FIG. 3 as reductions in the cross sectional area of the main body, it should be appreciated that similar functional constrictions can be produced by modifying the composition and/or density of the main body within a designated region without a reduction in cross sectional area.

It should be appreciated that in the operation of a heating element of the inventive concept, the electric and magnetic fields can be operated independently, in unison, sequentially, and/or in a time-dependent pattern. Similarly, the electric and magnetic fields of a heating element can be operated in a synchronous or asynchronous fashion. Such electric and/or magnetic fields can be configured to have a time and/or spatial relationship to the main body of the heating element. For example, an electric and/or magnetic field can be rotating with respect to all or part of the main body. Control of the electromagnetic field generators can be supplied by one or more field control circuits. Such field control circuits and other temperature sensitive components can be located at a distance from the main body of the heating element.

As described above, fuel species are selected that are responsive to the electric and/or magnetic fields of the heating element. In use, the electric and/or magnetic fields can act as a driving field for the fuel species. The application of such a driving field to the fuel species can be continuous (for example, using gradually changing or rotating fields). Alternatively, in some embodiments of the inventive concept application of the electric and/or magnetic fields can be discontinuous, intermittent, or exhibit other types of time-dependent variance. The movement of the fuel species in response to such a driving field can be rotary, periodic, oscillatory, non-uniform, or in the form of a superwave.

Another embodiment of the inventive concept is a system composed of two or more heating elements. The heating elements of such a system can be arranged in any suitable fashion, for example in a linear arrangement, a two dimensional array, or a three dimensional array. In such a system the heating elements can be controlled using a common control system, which controls the magnetic coils and/or voltage sources of all of the heating elements of the system. Alternatively, in other embodiments the heating elements of a system can be controlled by two or more control systems. In still other embodiments each heating element of a system can be controlled by its own control system.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An apparatus comprising;
a main body that is permeable to a fuel species, wherein the main body comprises a dopant with an affinity for the fuel species; and
a field source that provides a magnetic field, wherein at least a portion of the magnetic field intersects at least a portion of the main body.

2. The apparatus of claim 1, wherein the field source comprises a coil configured to provide the magnetic field.

3. The apparatus of claim 1, wherein the fuel species is responsive to the magnetic field.

5. The apparatus of claim 4, wherein the magnetic field provides an impulse to the fuel species that moves the fuel species through the main body.

6. An apparatus comprising;
a main body that is permeable to a fuel species, wherein the main body comprises a dopant with an affinity for the fuel species; and
a field source that provides an electric field, wherein at least a portion of the electric field intersects at least a portion of the main body.

7. The apparatus of claim 6, wherein the field source comprises an electrode configured to provide the electric field.

8. The apparatus of claim 6, wherein the fuel species is responsive to the electric field.

9. The apparatus of claim 8, wherein the electric field provides an impulse to the fuel species that moves the fuel species through the main body.

10. An apparatus comprising;
a main body that is permeable to a fuel species, wherein the main body comprises a dopant with an affinity for the fuel species;
a first field source that provides a first magnetic field, wherein at least a portion of the first magnetic field intersects at least a portion of the main body; and
a second field source that provides an electric field, wherein at least a portion of the electric field intersects at least a portion of the main body,
wherein the first magnetic field and the electric field are independent of one another.

11. The apparatus of claim 10, wherein the fuel species is responsive to the first magnetic field.

12. The apparatus of claim 10, wherein the fuel species is responsive to the electric field.

13. The apparatus of claim 10, wherein the first field source comprises a first coil.

14. The apparatus of claim 10, wherein the second field source comprises a first electrode.

15. The apparatus of claim 10, wherein the first field source comprises a first coil, the second field source comprises a first electrode, and wherein the first electrode of the second field source comprises the first coil.

16. The apparatus of claim 15, further comprising a third field source that includes a second coil and that provides a second magnetic field, wherein at least a portion of the second magnetic field intersects at least a portion of the main body, and wherein the second field source further comprises a second electrode wherein the second electrode comprises the second coil.

17. The apparatus of claim 16, further comprising a voltage source that is in electrical communication with the first electrode and the second electrode.

18. The apparatus of claim 10, further comprising a drive field, wherein the drive field comprises the first magnetic field and the first electric field, and wherein the drive field is configured to move the fuel species through the main body.

19. The apparatus of claim 18, wherein the drive field imparts a motion selected from the group consisting of a rotary motion, a periodic motion, an oscillatory motion, and a superwave motion to the fuel species.

20. A system comprising;
a plurality of heating elements, wherein each heating element comprises a main body that is permeable to a fuel species, wherein the main body comprises a dopant with an affinity for the fuel species, a first field source that provides a magnetic field wherein at least a portion of the magnetic field intersects at least a portion of the main body, and a second field source that provides an electric field wherein at least a portion of the electric field intersects at least a portion of the main body; and
a control system configured to modulate the activity of the first field source and the second field source of at least one of the plurality of heating elements.

21. The system of claim 20, wherein the plurality of heating elements is arranged in a linear arrangement.

22. The system of claim 20, wherein the plurality of heating elements is arranged in a two dimensional array.

23. The system of claim 20, wherein the plurality of heating elements is arranged in a three dimensional array.

24. The system of claim 20, wherein the control system is configured to control at least two of the plurality of heating elements.
